(19) United States
(12) Patent Application Publication
(10) Pub. No.: US 2006/0240861 A1
(43) Pub. Date: Oct. 26, 2006

(54) On-waiting apparatus of communication device

(75) Inventor: King-Yu Wang, Taipei City (TW)

Correspondence Address: Kin Star Tech Corp. & Florida RF Solutions Inc., P.O. Box No. 6-57, Junghe, Taipei, 235, TW

(73) Assignees: Kin Star Technology Corp., Taipei City (TW); Florida RF Solutions Inc., Coral Springs, FL (US)

(21) Appl. No.: 11/114,140

(22) Filed: Apr. 26, 2005

(51) Int. Cl. H04M 1/00

(52) U.S. Cl. 455/550.1; 379/433.1

(57) ABSTRACT

An on-waiting apparatus of communication device according to the invention provides a telephone capable of dialing for outgoing and receiving incoming calls via a communication device or a public telephone network, and is also capable of receiving incoming calls when already in connection using a multi-directional circuit and an exchange circuit thereof, thereby accomplishing on-waiting and multi-directional connection functions between the telephone, the public telephone network and the communication device.

### BACKGROUND OF THE INVENTION

(a) Field of the Invention

The invention relates to an on-waiting apparatus of communication device, and more particularly, to an on-waiting apparatus of communication device, in that the on-waiting apparatus is connected between a telephone, a public telephone network and a communication device.

(b) Description of the Prior Art

Quite a number of devices have been available for connecting between prior digital and analog communication devices in order to carry out communication. However, these prior devices merely offer one-directional connection, and other communication devices cannot be put through when the communication line is busy. For instance, when a line telephone network is in busy in communication with an indoor telephone, a mobile telephone or a network telephone cannot be put through. It is necessary that the precedent call be over and the following call be re-dialed to proceed with the new telephone call.

Using the above on-waiting apparatus, it is much likely that users omit importance of incoming calls. In addition, being capable of only one-directional connection, most communication devices offer rather unsatisfactory practicability and thus providing inadequate application efficiency.

### SUMMARY OF THE INVENTION

The invention is to provide an on-waiting apparatus of communication device, in that the on-waiting apparatus is connected between a telephone, a public telephone network and a communication device. The telephone is dialing outgoing calls and receiving incoming calls via the communication device or the public telephone network. In addition, when the telephone is in communication with the public telephone network or the communication device, supposed an incoming call is received from either of the public telephone network or the communication device that is not in use, on-waiting connection and multi-directional connection functions between the telephone, public telephone network and the communication device are accomplished using a multi-directional connection circuit and an exchange circuit.

The on-waiting call of communication device is capable of detecting whether incoming calls are received from the public network telephone and the communication device, and produces corresponding tones according to statuses such as on-waiting and on-hold statuses from either of the public network telephone and the communication device to inform a user of a current status. Meanwhile, the on-waiting apparatus of communication device is also capable of holding calls from either the public network telephone or the communication device and switching the calls to other connections, or connecting the calls for multi-directional connections.

Moreover, when being connected to a corresponding communication device, a connection interface of the on-waiting apparatus is capable of connecting to an Internet telephone using the Internet by connecting to a computer, a USB (Universal Serial Bus) controller, a Bluetooth interface or a 802.11 module.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a system block diagram according to the invention.

FIG. 2 shows an embodiment according to the invention.

FIG. 3 shows a first block diagram of an embodiment according to the invention.

FIG. 4 shows a second block diagram of an embodiment according to the invention.

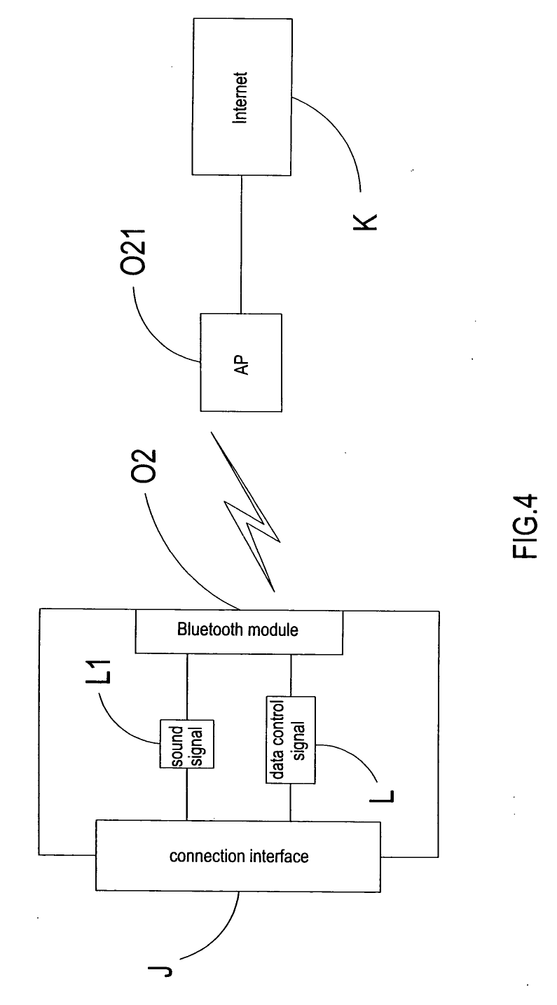

FIG. 5 shows a third block diagram of an embodiment according to the invention.

### DETAILED DESCRIPTION OF THE PREFERRED EMBODIMENTS

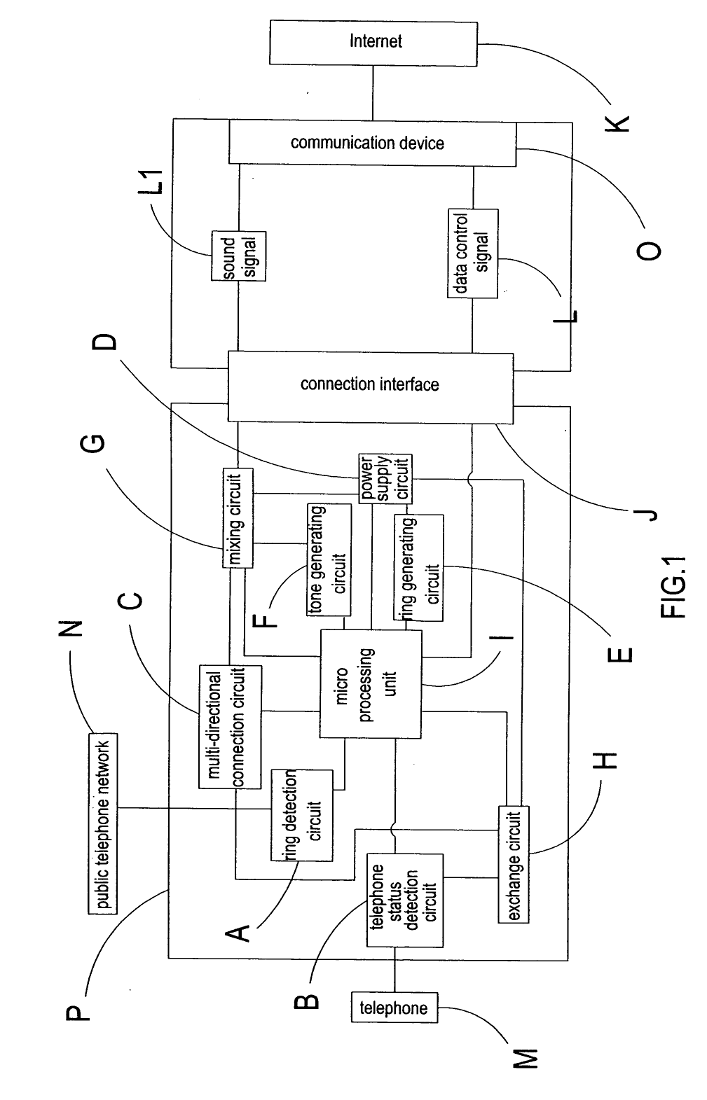

Referring to FIG. 1 showing an on-waiting apparatus of communication device according to the invention, an on-waiting apparatus P comprises a ring detection circuit A, a telephone status detection circuit B, a multi-directional connection circuit C, a power supply circuit D, a ring generating circuit E, a tone generating circuit F, a mixing circuit G, an exchange circuit H, a micro processing unit 1, a connection interface J and a communication device O.

The ring detection circuit A is for detecting existence of incoming calls, and sending signals into the micro processing unit I.

The telephone status detection circuit B is for detecting whether a telephone M is on-hook or off-hook, detecting specific numbers entered and sending signals into the micro processing unit I.

The multi-directional connection circuit C is for simultaneously initiating connection between a public telephone network N, the telephone M and the communication device O, or maintaining connection of the public telephone network N.

The power supply circuit D is for providing operating power of the telephone M and other circuits.

The ring generating circuit E is for generating a ring when the communication device 0 receives an incoming call.

The tone generating circuit F is for receiving control signals from the micro processing unit I, producing corresponding dialing tone, connecting on-hold tone, connection confirmation tone, and other related tones of connection.

The mixing circuit G is for converting signals between the telephone M and the communication device O, as well as switching 2-line and 4-line audio lines.

The exchange circuit H is for receiving control signals form the micro processing unit I, and is located between the telephone M, the public telephone network N and the communication device O to connect calls.

The micro processing unit I is connected to all internal circuits, and is for controlling on-waiting calls, multi-directional calls, on-hold calls and other related audio connection.

The connection interface J is for sending and receiving control signals and audio signals of the on-waiting apparatus P to the communication device O, and connecting correspondingly to different communication devices O.

Flows of the aforesaid main components are to be described below.

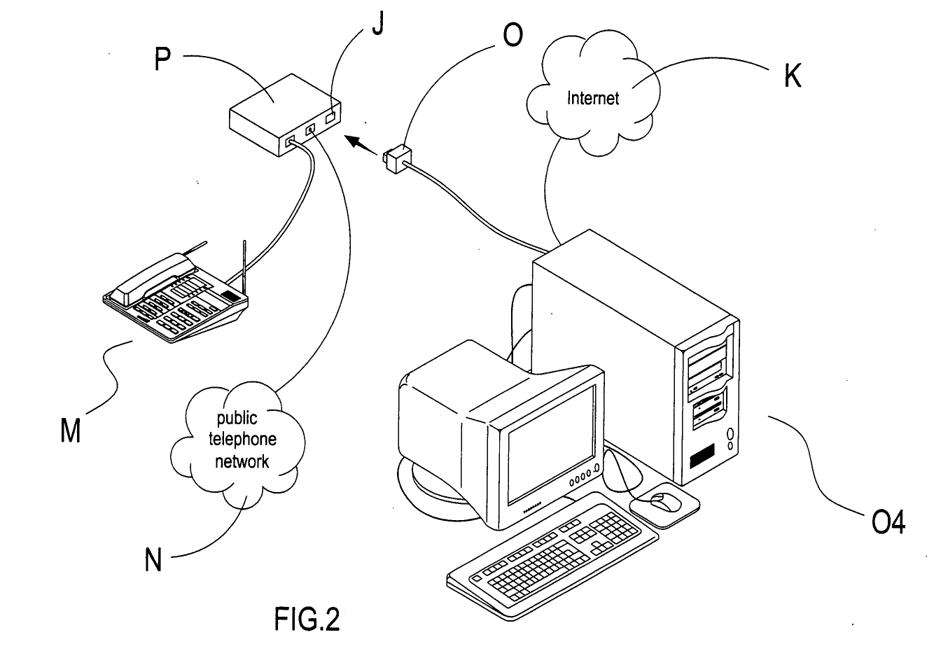

I. Procedures for picking up a telephone call (with reference to FIG. 2)

The micro processing unit I is at idle, and the exchange circuit H is directly connected to the public telephone network N.

(1) To connect an incoming call K via the public telephone network N:

The public telephone network N sends ring signals, which are detected by the ring detection circuit A that further notifies the micro processing unit I. The telephone M rings upon receiving the ring signals by the micro processing unit I.

When a user picks up a telephone handset, the telephone status detection circuit B detects an off-hook status for answering the incoming call, and sends detection signals to the micro processing unit I, which is then informed about the off-hook status of the telephone M.

When the user hangs up the telephone handset, the telephone status detection circuit B detects an off-hook as the call is terminated, and sends the signals to the micro processing unit I, which returns to an idle status.

(2) To connect an incoming call via the Internet network K:

The communication device O (system software with Internet audio protocol of a computer O4 for instance) receives signals of an incoming call from the Internet, and sends a data control signal L to the micro processing unit I via the connection interface J. The micro processing unit I activates the ring generating circuit E to enable the exchange circuit H to connect to the telephone M. The ring signals pass through the power supply circuit D, the exchange circuit H and the telephone status detection circuit B to enter the telephone M, which rings at this point. When a user picks up the telephone handset for answering a call, the telephone status detection circuit B detects an off-hook status, and sends detection signals to the micro processing unit I, which then deactivates the ring generating circuit E to stop ringing.

Next, the micro processing unit I activates the mixing circuit G, and simultaneously sends conversation signals that command the communication device O (service system with Internet audio protocol of the computer O4 for instance) to prompt for conversation.

When the user hangs up the telephone handset, the telephone status detection circuit B detects on-hook signals, and sends detection signals to the micro processing unit I, which then discontinues a path of the mixing circuit G. At the same time, the exchange circuit H restores connection with the public telephone network N. The micro processing unit I also sends the on-hook signals to inform the communication device O (service system with Internet audio protocol of the computer O4 for instance), and returns to an idle status.

II. Procedures for dialing an outgoing telephone call (with reference to FIG. 2)

The micro processing unit I is at an idle status, and the exchange circuit H is directly connected to the public telephone network N.

(1) To connect an outgoing call I via the public telephone network N:

When a user pick up the telephone handset, the telephone status detection circuit B detects off-hook signals, and transmits detection signals to the micro processing unit I. The user enters telephone number as supposed to. The telephone status detection circuit B detects dual-tone multi-frequency signals, and then sends detection signals to the micro processing unit I. The micro processing unit I identifies that the telephone number is valid, and does not take further steps, so that the user is allowed to make the outgoing call for conversation through the public telephone network N. When the user hangs up the telephone handset, the telephone status detection circuit B detects an on-hook status, and sends detection signals to the micro processing unit I, which returns to an idle status.

(2) To connect an outgoing call via the Internet K:

When a user picks up the telephone handset, the telephone status detection circuit B detects off-hook signals, and sends detection signals to the micro processing unit I. When the user presses a specific button such as # or * to select the Internet telephone as a path for an outgoing call, the telephone status detection circuit B sends detection signals to the micro processing unit I when having detected that the specific button such as # or * is before the telephone number, such that the micro processing unit I activates the switching circuit H and the telephone M to operate using electric power from the power supply circuit D. Meanwhile, the telephone status detection circuit B continues to detect numbers entered by the user until a specific button such as # or * is again entered, and sends signals of all numbers entered by the user to the micro processing unit I. The micro processing unit I identifies that the numbers entered between pressing the two specific buttons such as # or * are the telephone number the user wishes to dial, and sends out the telephone number dialed. (Supposed a virtual telephone number is edited in the personal computer O4 to represent an Internet protocol address of the Internet K, an IP address is reflected when the service system software having Internet audio protocol accepts the virtual telephone number. Therefore, the Internet K telephone can also be dialed using the aforesaid method.) Meanwhile, the micro processing unit I activates the mixing circuit G for connection to initiate a conversation. When the user hangs up the telephone handset, the telephone status detection circuit B detects an on-hook status, and sends detection signals to the micro processing unit I, which sends on-hook signals to the communication device O (the computer O4 and a service system with Internet audio protocol for instance), such that the exchange-circuit H restores connection with the public telephone network N, and the micro processing unit returns to an idle status.

III. Procedures for dialing an on-waiting call (with reference to FIG.

(1) During a connection between the telephone M and an Internet telephone (as the aforesaid connection procedures):

When the public telephone network N receives ringing of an incoming call, the ring detection circuit A detects ring signals and informs the micro processing unit I. The micro processing unit I activates the tone generating circuit F to produce an on-waiting tone. The on-waiting tone is transmitted to the telephone M via the mixing circuit G, the power supply circuit D and the exchange circuit H, and is then heard by the user.

Supposed the user presses the flash button or handset hook, the telephone status detection circuit B detects operations of the telephone M and notifies the micro processing unit I. The micro processing unit I changes operation of the exchange circuit, and commands the exchange circuit to connect to the public telephone network N to prompt connection between the user and the public telephone network N. Meanwhile, the micro processing unit I continues to send signals to the communication device O (the computer O4 and service system software with Internet audio protocol for instance) to maintain the network telephone path.

Supposed the user again presses the flash button or the handset hook, the telephone status detection circuit B detects operations of the telephone M and notifies the micro processing unit I. The micro processing unit I commands the exchange circuit H to connect the network telephone and sends signals to the communication device O (the computer O4 service system software with Internet audio protocol for instance), and enables the multi-directional connection circuit C to maintain connection with the public telephone network N.

(2) During a connection between the telephone M and the public telephone network N (as the aforesaid connection procedures):

When the communication device O (the computer O4 and service system software with Internet audio protocol of for instance) receives incoming ring signals, the ring signals are sent to the connection interface J via the communication device O (the computer O4 and service system software with Internet audio protocol of for instance), and the data control signal L is sent to the micro processing unit I via the connection interface J. The micro processing unit I commands the tone generating circuit F to produce an on-waiting tone, and a path between the mixing circuit G and the multi-directional connection circuit C to transmit the on-waiting tone. The on-waiting tone is transmitted to the telephone M via the mixing circuit G, the power supply circuit D and the exchange circuit H, and is then heard by the user.

Supposed the user presses the flash button or handset hook, the telephone status detection circuit B detects operations of the telephone M and notifies the micro processing unit I. The micro processing unit I changes operation of the exchange circuit H, and commands the exchange circuit H to connect to the power supply circuit D. Also, the micro processing unit I sends signals to the communication device O to prompt the telephone M to connect with the network telephone via the communication device O (the computer O4 and service system software with Internet audio protocol for instance). At the same time, the micro processing unit I sends continual signals to the multi-directional connection circuit C to enable the multi-directional connection circuit C to maintain connection with the public telephone network N.

Supposed the user again presses the flash button or the handset hook, the telephone status detection circuit B detects operations of the telephone M and notifies the micro processing unit I. The micro processing unit I commands the exchange circuit H to restore connection with the public telephone network N to prompt connection between the telephone M and the public telephone network N, and sends continual signals to the communication device O to maintain the Internet telephone path.

IV. For multi-directional connections between the telephone M, the public telephone network N and the communication device O (the computer O4 and service system software with Internet audio protocol for instance)

During an on-waiting status as described by the aforesaid procedures for on-waiting calls, when a user enters specific numbers such as *3# or #5#, the telephone detection status circuit B detects the specific numbers such as *3# or #5# entered, and sends detection signals to the micro processing unit I. The micro processing unit I changes operations of the switching circuit H to command the switching circuit to connect with the public telephone network N, while also activates the multi-directional connection circuit C and the mixing circuit G and sends connection signals to the communication device (the computer O4 and service system software with Internet audio protocol for instance) to connect with the Internet telephone K, thereby establishing multi-directional connections.

When the user hangs up the telephone handset, the telephone status detection circuit B detects an on-hook status, and sends detection signals to the micro processing unit I, which deactivates operations of all circuits and sends on-hook signals to the communication device (the computer O4 and service system software with Internet audio protocol for instance) to return to an idle status.

Referring to FIG. 2 showing an on-waiting apparatus of communication device in an embodiment of according to the invention, an on-waiting apparatus P is simultaneously connected to a telephone M, a public telephone network N and a computer O4, wherein the computer O4 is connected to Internet K. A user can dial for outgoing calls selectively from using the telephone M, or using connection from the public telephone network N to the Internet K via the computer O4. Either of the aforesaid paths can be used for connection, during which incoming calls received from the other is still capable of on-waiting or multi-directional connection functions.

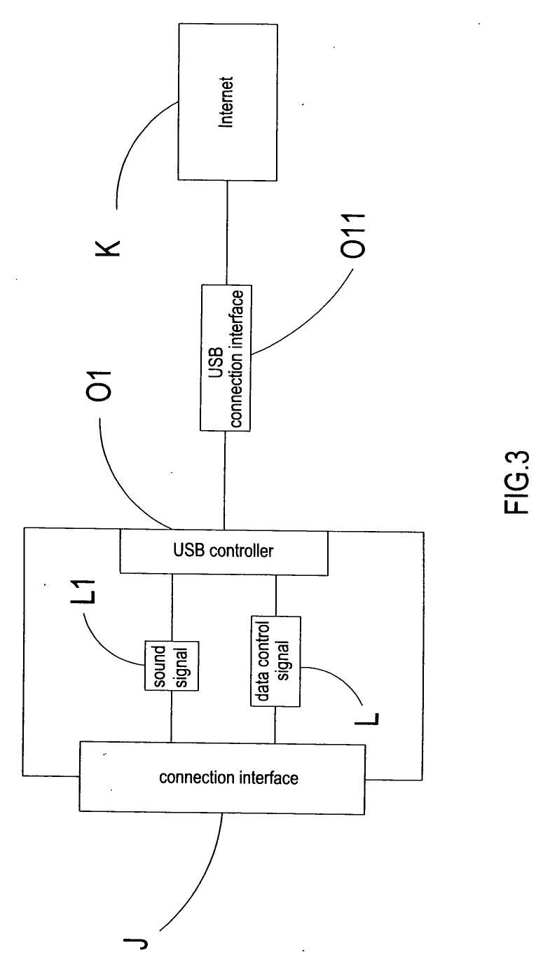

Referring to FIG. 3 along with FIG. 1, a connection interface is connected to a wired USB controller O1, and is connected to the Internet K via a USB interface O11, thereby enabling the telephone M to make outgoing Internet calls via the on-waiting apparatus P to any point on the Internet, and sending and receiving audio signals L1 as well as data control signals L via the connection interface J to the USB controller O1.

Referring to FIG. 3 along with FIG. 1, the connecting interface J is connected to a Bluetooth module O2, and via wireless connection between the Bluetooth O2 and an access point (AP) O21, is connected to the Internet K, thereby enabling the telephone M to make outgoing Internet calls via the on-waiting apparatus P to any point on the Internet, and sending and receiving audio signals L1 as well as data control signals L via the connection interface J to the Bluetooth module O2.

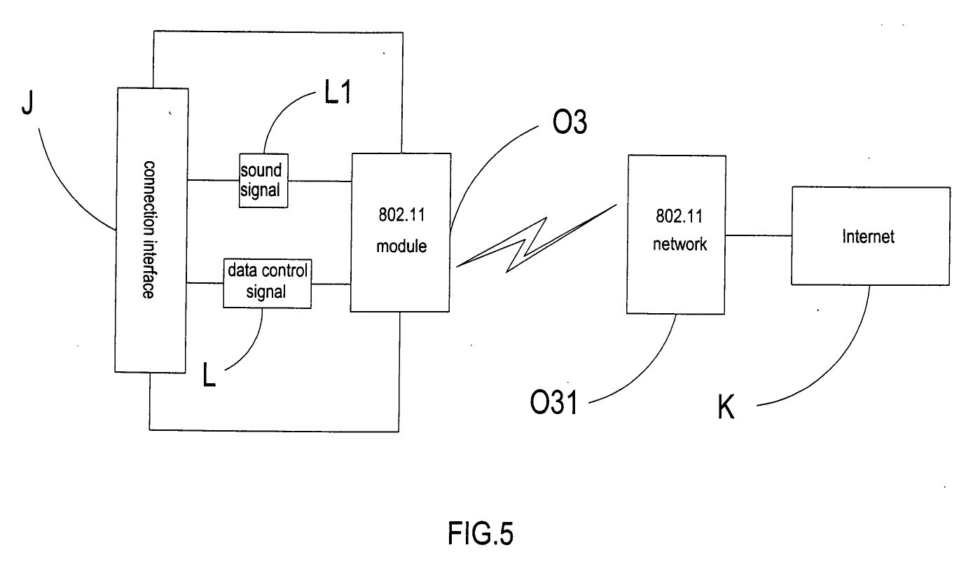

Referring to FIG. 5 along with FIG. 1, the connection interface is connected to a 802.11 module O3 further connected to a 802.11 network O31 using direct wireless connection, wherein the 802.11 network O31 is connected to the Internet K, thereby enabling the telephone M to make outgoing Internet calls via the on-waiting apparatus P to any point on the Internet, and sending and receiving audio signals L1 as well as data control signals L via the connection interface J to the 802.11 module O3.

To distinguish novelty and practicability of the invention, excellences of the invention are:
1. the Internet telephone being capable of receiving incoming calls and dialing for outgoing calls using a conventional telephone;.
2. the connection interface having high compatibility to wire and wireless devices like USB controllers, Bluetooth modules, and 802.11 modules to be connected to the Internet;
3. providing on-waiting functions between the public telephone network and the Internet telephone;
4. providing three-directional connection between the public telephone network and the Internet telephone;
5. elevating repeated usability and application efficiency between communication devices;
6. preventing users from missing important incoming calls;
7. offering industrial competitiveness;
8. providing commercial values; and
9. having novelty and advancement.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An on-waiting apparatus of communication device, comprising a ring detection circuit, a telephone status detection circuit, a multi-directional connection circuit, a power supply circuit, a ring generating circuit, a tone generating circuit, a mixing circuit, an exchange circuit, a micro processing unit, a connection interface and a communication device; wherein:
the ring detection circuit is for detecting existence incoming calls from a public telephone network, and sending detected signals to the micro processing unit;
the telephone status detection circuit is for detecting whether the telephone is at an on-hook or off-hook status, detecting specific numbers entered, and sending detected signals to the micro processing unit;
the multi-directional connection circuit is for providing connections between the public telephone network, the telephone and the communication device, or maintaining connections from the public telephone network;
the power supply circuit is for providing the telephone and other circuits with operating electric power;
the ring generating circuit is for producing ringing when receiving incoming calls from the communication device;
the tone generating circuit is for receiving control signals from the micro processing unit to further produce corresponding dialing tones, connection on-waiting tones, confirmation tones, and other related tones during connections;
the mixing circuit is for switching between the telephone and the communication device, including switching between 2-line and 4-line audio lines;
the exchange circuit is for receiving control signals from the micro processing unit, and is located between the telephone and the public telephone network to prompt connection with the communication device;
the micro processing unit is connected with all internal circuits, and is for controlling on-waiting calls, multi-directional connections, on-hold calls and other related controls of audio connections; and
the connection interface is for sending and receiving control signals and audio signals of the on-waiting apparatus to the communication device, and for prompting connection correspondingly to different communication devices;
thereby, the telephone is enabled to dial for outgoing calls and receive incoming calls via the communication device or the public telephone network, while being capable of receiving incoming calls when already in connection using a multi-directional circuit and an exchange circuit thereof for accomplishing on-waiting and multi-directional connection functions between the telephone, the public telephone network and the communication device.

2. The on-waiting apparatus of communication device in accordance with claim 1, wherein the communication device connected with the connection interface is a direct communication device or an indirect communication device;
with the direct communication device being a device capable of dialing for outgoing calls and receiving incoming calls, and including mobile phones, walkie-talkies, and related devices having wireless transmission and wireless reception capabilities; and
with the indirect communication device being a device capable of directly or indirectly connecting to the Internet, and including USB control modules and USB connection interfaces, 802.11 modules and 802.11 networks, Bluetooth modules and access points, and related devices capable of connecting to the Internet.
